(19) United States
(12) Patent Application Publication
(10) Pub. No.: US 2024/0219922 A1
(43) Pub. Date: Jul. 4, 2024

(54) MOVING BODY, MOVEMENT CONTROL METHOD, AND PROGRAM

(71) Applicant: Sony Group Corporation, Tokyo (JP)

(72) Inventors: Takuto MOTOYAMA, Tokyo (JP); Kohei URUSHIDO, Tokyo (JP); Masaki HANDA, Tokyo (JP); Masahiko TOYOSHI, Tokyo (JP); Shinichiro ABE, Tokyo (JP)

(73) Assignee: Sony Group Corporation, Tokyo (JP)

(21) Appl. No.: 18/558,540

(22) PCT Filed: Feb. 1, 2022
(86) PCT No.: PCT/JP2022/003738

§ 371 Date: Nov. 2, 2023

(30) Foreign Application Priority Data
May 10, 2021 (JP) 2021-079528

(51) Int. Cl. G05D 1/622; G05D 1/242; G05D 1/243; G05D 111/10; G06T 7/11; G06T 7/50; G06V 20/17; G08G 5/00

(52) U.S. Cl. CPC G05D 1/622; G05D 1/242; G05D 1/243; G06T 7/11; G06T 7/50; G06V 20/17; G08G 5/0069; G05D 2111/10; G06T 2207/10024; G06T 2207/10028; G06T 2207/10032; G06T 2207/30181

(57) ABSTRACT

The present disclosure relates to a moving body, a movement control method, and a program capable of suppressing erroneous determination in obstacle detection.

A normal vector estimation unit estimates a normal vector on the basis of sensor data obtained by sensing an object in a traveling direction of the own device, and a control information estimation unit generates control information for controlling movement of the own device on the basis of the normal vector. Technology according to the present disclosure can be applied to, for example, a moving body such as a drone.

### TECHNICAL FIELD

The present disclosure relates to a moving body, a movement control method, and a program, and more particularly, to a moving body, a movement control method, and a program capable of suppressing erroneous determination in obstacle detection.

### BACKGROUND ART

Some moving bodies such as drones have a function of decelerating or stopping in a case where an obstacle having a possibility of collision is detected on a trajectory in a traveling direction.

However, in a case where the drone flies at a low altitude near the ground, the ground is detected as an obstacle having a possibility of collision, and the drone stops unintentionally.

Meanwhile, Patent Document 1 discloses a technique of detecting a normal vector in units of pixels from a polarized image transmitted through a plurality of polarizing filters having different polarization directions.

### CITATION LIST

### Patent Document

Patent Document 1: Japanese Patent Application Laid-Open No. 2015-114307

### SUMMARY OF THE INVENTION

### Problems to be Solved by the Invention

If the normal vector can be detected on the trajectory in the traveling direction, it is considered that the accuracy of determination in obstacle detection can be improved.

The present disclosure has been made in view of such a situation, and aims to suppress erroneous determination in obstacle detection.

### Solutions to Problems

A moving body of the present disclosure is a moving body including: a normal vector estimation unit that estimates a normal vector on the basis of sensor data obtained by sensing a traveling direction of an own device; and a control information generation unit that generates control information for controlling movement of the own device on the basis of the normal vector.

A movement control method of the present disclosure is a movement control method including: estimating a normal vector on the basis of sensor data obtained by sensing an object in a traveling direction of a moving body; and generating control information for controlling movement of the moving body on the basis of the normal vector.

A program of the present disclosure is a program for causing a computer to execute processing of: estimating a normal vector on the basis of sensor data obtained by sensing an object in a traveling direction of a moving body; and generating control information for controlling movement of the moving body on the basis of the normal vector.

In the present disclosure, a normal vector is estimated on the basis of sensor data obtained by sensing an object in a traveling direction of a moving body, and control information for controlling movement of the moving body is generated on the basis of the normal vector.

### BRIEF DESCRIPTION OF DRAWINGS

FIG. 1 is a diagram for explaining detection of an obstacle of a moving body.

FIG. 2 is a diagram for explaining an example of erroneous detection of an obstacle.

FIG. 3 is a diagram for explaining an outline of the technology according to the present disclosure.

FIG. 4 is a block diagram illustrating a hardware configuration example of a moving body.

FIG. 5 is a block diagram illustrating a functional configuration example of a moving body according to the first embodiment.

FIG. 6 is a flowchart for explaining a flow of obstacle detection processing.

FIG. 7 is a flowchart for explaining a flow of obstacle detection processing.

FIG. 8 is a diagram for explaining division of collision determination regions.

FIG. 9 is a diagram for explaining calculation of a collision risk for each collision determination region.

FIG. 10 is a diagram for explaining an area of a real space of point cloud data.

FIG. 11 is a diagram for explaining setting of an obstacle region.

FIG. 12 is a diagram for explaining correction of a trajectory.

FIG. 13 is a block diagram illustrating a functional configuration example of a moving body according to a second embodiment.

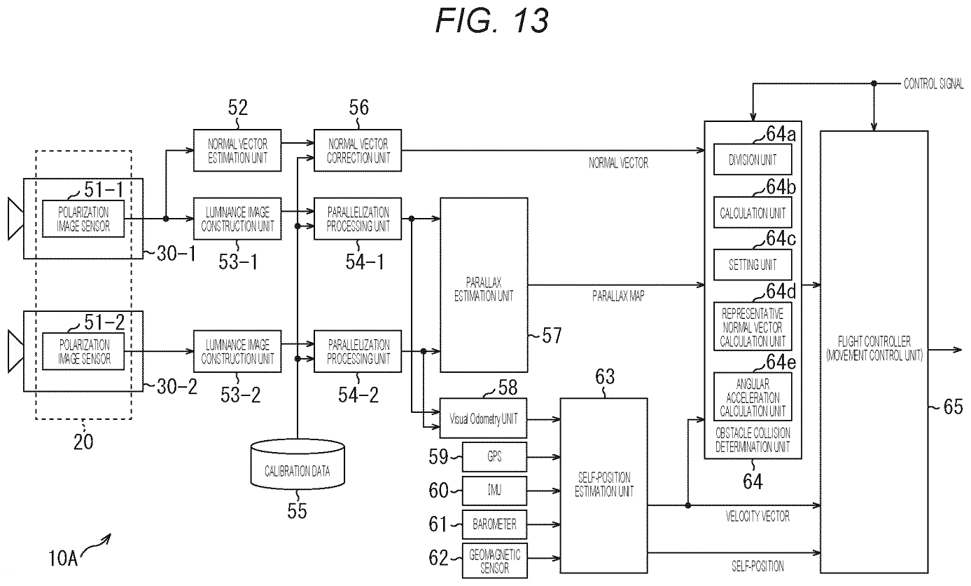

FIG. 14 is a flowchart for explaining a flow of obstacle detection processing.

FIG. 15 is a flowchart for explaining a flow of trajectory correction processing.

FIG. 16 is a diagram for explaining estimation of a representative normal vector.

FIG. 17 is a diagram for explaining calculation of angular acceleration.

FIG. 18 is a block diagram illustrating a functional configuration example of a moving body according to a third embodiment.

FIG. 19 is a flowchart for explaining a flow of superimposed image transmission processing.

FIG. 20 is a diagram illustrating an example of superimposing a normal vector image on an RGB image.

FIG. 21 is a diagram illustrating an example of a sensor.

FIG. 22 is a block diagram illustrating a functional configuration example of a moving body control system.

FIG. 23 is a diagram illustrating a configuration example of a computer.

### MODE FOR CARRYING OUT THE INVENTION

Hereinafter, modes for carrying out the present disclosure (hereinafter referred to as embodiments) will be described. Note that the description will be made in the following order.
1. Problems of Prior Art and Outline of Technology According to Present Disclosure
2. Hardware Configuration of Moving Body
3. First Embodiment (Movement Control Based on Normal Vector)
4. Second Embodiment (Trajectory Correction Based on Normal Vector)
5. Third Embodiment (Superimposition of Normal Vector Image on RGB Image)
6. Modification
7. Configuration Example of Computer

### 1. PROBLEMS OF PRIOR ART AND OUTLINE OF TECHNOLOGY ACCORDING TO PRESENT DISCLOSURE

Some moving bodies such as drones have a function of decelerating or stopping in a case where an obstacle having a possibility of collision is detected on a trajectory in a traveling direction.

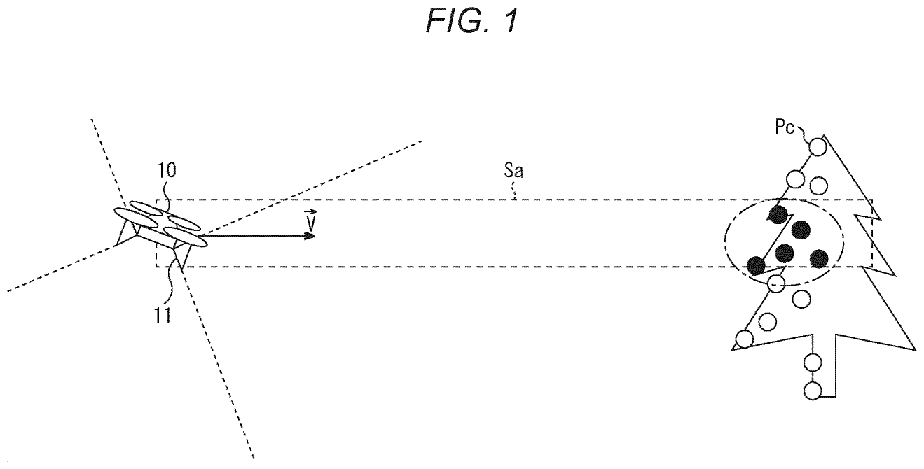

For example, as illustrated in FIG. 1, it is assumed that a moving body 10 configured as a drone is flying in the air with a velocity vector v by the user's operation. The moving body 10 includes a distance measuring sensor 11 including a stereo camera or the like. The moving body 10 can acquire the point cloud data Pc by the distance measuring sensor 11.

In the drawing, as surrounded by a frame of a one-dot chain line, in a case where the point cloud data Pc exists on the spatial region Sa through which the moving body 10 passes along the predicted future trajectory, the moving body 10 determines that an obstacle having a possibility of collision has been detected, and decelerates or stops.

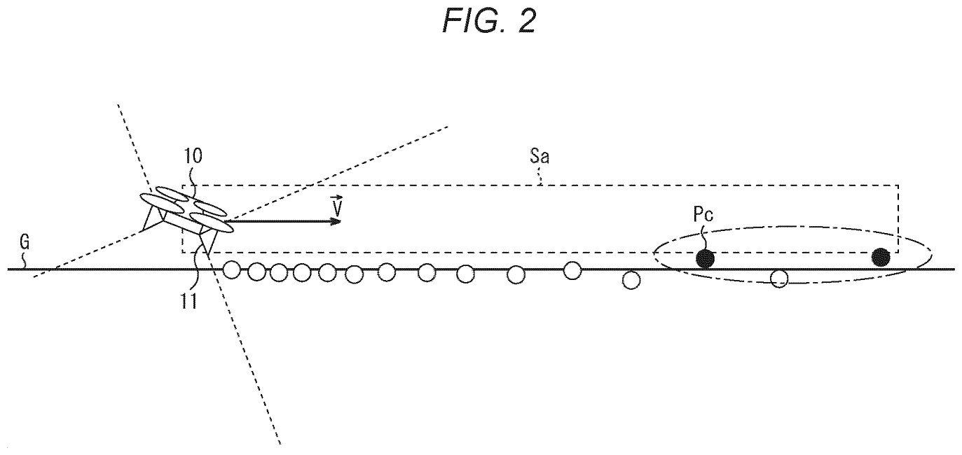

However, as illustrated in FIG. 2, in a case where the moving body 10 flies at a low altitude near the ground G, there is a possibility that the point cloud data Pc near the ground G is included in the collision determination region for determining the detection of the obstacle due to a distance measurement error or fluctuation due to accuracy. Furthermore, in a case where the moving body 10 flies at a low altitude near the ground G, the collision determination region may overlap the ground G due to an error of the velocity vector v or the like. As a result, the ground G is detected as an obstacle having a possibility of collision, and the moving body 10 stops unintentionally. This may occur not only during low altitude flight but also during high speed flight.

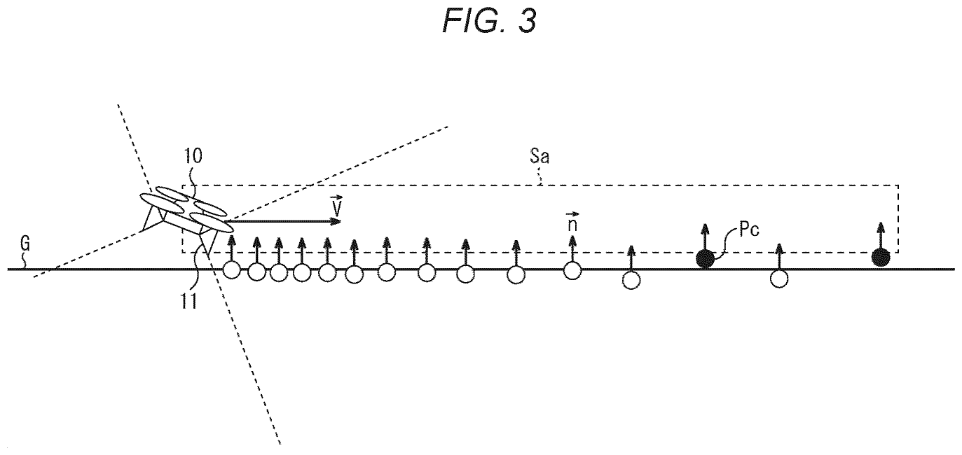

Therefore, as illustrated in FIG. 3, the moving body 10 to which the technology according to the present disclosure is applied estimates the normal vector n for the point cloud data Pc on the basis of the sensor data obtained by sensing the traveling direction of the own device. The sensor data is, for example, a polarized image captured by a polarization image sensor. Then, the moving body 10 calculates the collision risk for each point cloud data Pc on the basis of the estimated normal vector n to determine whether or not to decelerate or stop. The collision risk for the point cloud data Pc is calculated according to how much the normal vector n for the point cloud data Pc and the velocity vector v of the moving body 10 face the same direction.

As a result, even in a case where the moving body 10 is flying at a low altitude or at a high speed, it is possible to suppress erroneous determination in obstacle detection.

### 2. HARDWARE CONFIGURATION OF MOVING BODY

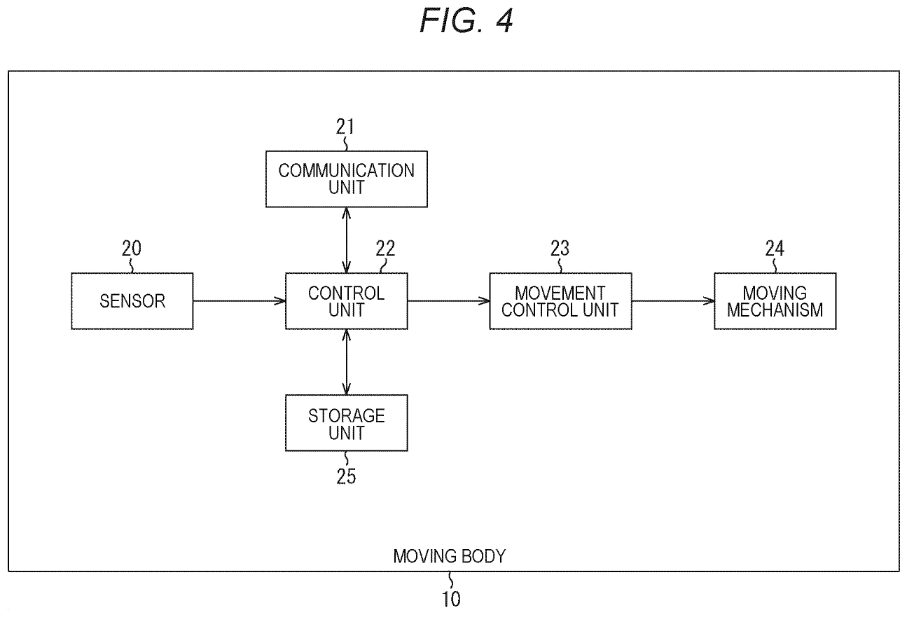

FIG. 4 is a block diagram illustrating a hardware configuration example of the moving body 10.

The moving body 10 includes a moving object such as a drone, a vehicle, or a ship. Hereinafter, an example in which the technology according to the present disclosure is applied to a drone flying in the air will be described. The technology according to the present disclosure can be applied to a drone that autonomously flies, an autonomous traveling vehicle that moves on land, an autonomous navigation vessel that moves on water or under water, and autonomous mobile robots such as an autonomous mobile cleaner that moves indoors, in addition to a moving body that moves by user's operation.

The moving body 10 includes a sensor 20, a communication unit 21, a control unit 22, a movement control unit 23, a moving mechanism 24, and a storage unit 25.

The sensor 20 includes various sensors including the above-described distance measuring sensor 11, and senses each direction around the moving body 10 including the traveling direction of the moving body 10. Sensor data obtained by sensing is supplied to the control unit 22.

The communication unit 21 includes a network interface or the like, and performs wireless or wired communication with the controller for operating the moving body 10 and any other device. For example, the communication unit 21 may directly communicate with a device to be communicated with, or may perform network communication via a base station or a repeater for Wi-Fi (registered trademark), 4G, 5G, or the like.

The control unit 22 includes a central processing unit (CPU), a memory, and the like, and controls the communication unit 21, the movement control unit 23, and the storage unit 25 by executing a predetermined program. For example, the control unit 22 controls the movement control unit 23 on the basis of the sensor data from the sensor 20.

The movement control unit 23 includes a circuit such as a dedicated IC or a field-programmable gate array (FPGA), and controls driving of the moving mechanism 24 under the control of the control unit 22.

The moving mechanism 24 is a mechanism for moving the moving body 10, and includes a flight mechanism, a traveling mechanism, a propulsion mechanism, and the like. In this example, the moving body 10 is configured as a drone, and the moving mechanism 24 includes a motor, a propeller, and the like as a flight mechanism. Furthermore, in a case where the moving body 10 is configured as an autonomous traveling vehicle, the moving mechanism 24 includes wheels or the like as a traveling mechanism. In a case where the moving body 10 is configured as an autonomous navigation vessel, the moving mechanism 24 includes a screw propeller and the like as a propulsion mechanism. The moving mechanism 24 is driven according to the control of the movement control unit 23 to move the moving body 10.

In the moving body 10, the control unit 22 drives the moving mechanism 24 by controlling the movement control unit 23 according to a control signal from the controller received by the communication unit 21, for example. As a result, the moving body 10 moves according to the operation of the controller by the user.

The storage unit 25 includes a nonvolatile memory such as a flash memory, and stores various types of information according to control of the control unit 22.

Hereinafter, embodiments of the moving body 10 that realize suppression of erroneous determination in obstacle detection will be described.

### 3. FIRST EMBODIMENT

### (Functional Configuration Example of Moving Body)

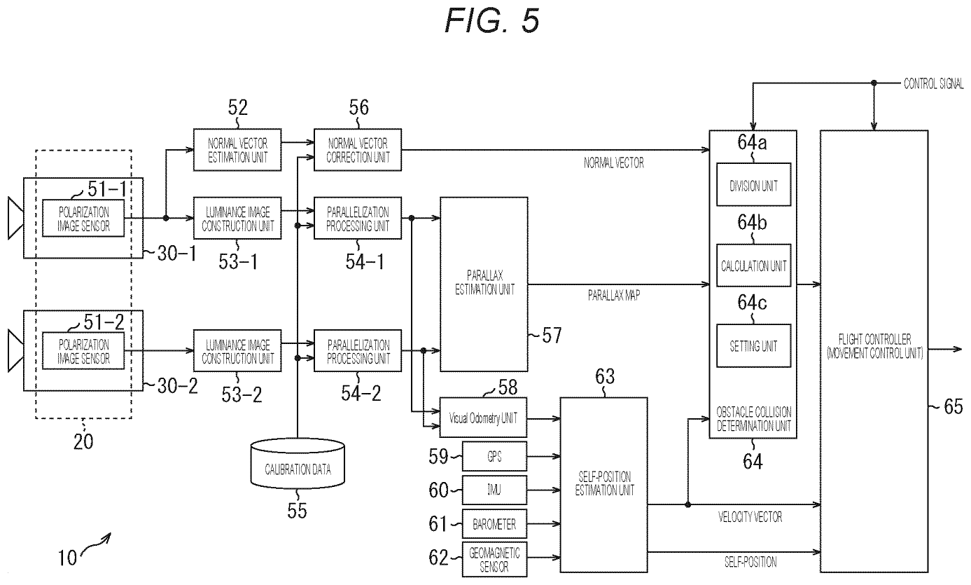

FIG. 5 is a block diagram illustrating a functional configuration example of the moving body 10 of the first embodiment to which the technology according to the present disclosure is applied.

The moving body 10 illustrated in FIG. 5 includes two polarization cameras 30-1 and 30-2. The polarization cameras 30-1 and 30-2 include polarization image sensors 51-1 and 51-2, respectively, and also function as stereo cameras.

The polarization image sensors 51-1 and 51-2 are configured by forming polarizers in a plurality of directions on photodiodes of pixels, respectively. For example, polarizers in four directions are mounted on the polarization image sensors 51-1 and 51-2, and polarized images in the four directions can be acquired. The polarization image sensors 51-1 and 51-2 are one of various sensors constituting the sensor 20 in FIG. 4. Hereinafter, in a case where the polarization image sensors 51-1 and 51-2 are not distinguished from each other, they are simply referred to as polarization image sensors 51.

The moving body 10 further includes a normal vector estimation unit 52, luminance image construction units 53-1 and 53-2, parallelization processing units 54-1 and 54-2, calibration data 55, and a normal vector correction unit 56.

The normal vector estimation unit 52 estimates a normal vector for each pixel position of the polarized image on the basis of the polarized image acquired by the polarization image sensor 51-1. The polarized image used for estimating the normal vector may be a polarized image acquired by the polarization image sensor 51-2.

Specifically, the normal vector estimation unit 52 obtains the relationship between the luminance and the polarization angle from the polarization direction and the luminance of the polarized image on the basis of the polarized image having three or more polarization directions, and determines the azimuth angle φ at which the luminance is the maximum. Furthermore, the normal vector estimation unit 52 calculates the polarization degree p using the maximum luminance and the minimum luminance obtained from the relationship between the luminance and the polarization angle, and determines the zenith angle θ corresponding to the polarization degree p on the basis of the characteristic curve indicating the relationship between the polarization degree and the zenith angle. In this way, the normal vector estimation unit 52 estimates the azimuth angle φ and the zenith angle θ for each pixel position as the normal vector of the subject on the basis of the polarized image having three or more polarization directions.

The luminance image construction units 53-1 and 53-2 configure two-view luminance images on the basis of the luminance values for each pixel of the two-view polarized images acquired by the polarization image sensors 51-1 and 51-2, respectively.

The parallelization processing units 54-1 and 54-2 perform parallelization processing by stereo rectification on the two-view luminance images configured by the luminance image construction units 53-1 and 53-2, respectively. The parallelization processing is performed using the internal parameters, the external parameters, and the distortion coefficients of the polarization cameras 30-1 and 30-2 held as the calibration data 55. By the parallelization processing, the two-view luminance images are corrected into parallelized luminance images.

The normal vector correction unit 56 corrects the normal vector estimated for each pixel position of the polarized image according to the correction of the luminance image by the parallelization processing by the parallelization processing units 54-1 and 54-2. Internal parameters, external parameters, and distortion coefficients of the polarization cameras 30-1 and 30-2 are also used for correction of the normal vector.

The moving body 10 further includes a parallax estimation unit 57, a visual odometry unit 58, a GPS sensor 59, an IMU 60, a barometer 61, a geomagnetic sensor 62, and a self-position estimation unit 63.

The parallax estimation unit 57 estimates the parallax on the luminance image by stereo matching using the luminance image after the parallelization processing. On the basis of the estimated parallax, the parallax estimation unit 57 outputs a parallax map including point cloud data indicating the distance (depth) to the subject.

The visual odometry unit 58 estimates the trajectory of the own device (moving body 10) by visual odometry on the basis of the luminance image after the parallelization processing, and supplies the trajectory to the self-position estimation unit 63.

The global positioning system (GPS) sensor 59 acquires GPS information of the own device (moving body 10) and supplies the GPS information to the self-position estimation unit 63. The inertial measurement unit (IMU) 60 detects a three-dimensional angular velocity and acceleration of the own device (moving body 10), and supplies the three-dimensional angular velocity and acceleration to the self-position estimation unit 63. The barometer 61 measures the atmospheric pressure and supplies the atmospheric pressure to the self-position estimation unit 63. The geomagnetic sensor 62 detects geomagnetism and supplies the detected geomagnetism to the self-position estimation unit 63. Each of the GPS sensor 59, the IMU 60, the barometer 61, and the geomagnetic sensor 62 is also one of various sensors constituting the sensor 20 in FIG. 4.

The self-position estimation unit 63 performs sensor fusion using the extended Kalman filter on the basis of data obtained by each of the visual odometry unit 58, the GPS sensor 59, the IMU 60, the barometer 61, and the geomagnetic sensor 62. As a result, the self-position estimation unit 63 can calculate the self-position and the velocity vector of the own device (moving body 10).

The moving body 10 further includes an obstacle collision determination unit 64 and a flight controller 65.

The obstacle collision determination unit 64 determines the possibility of collision of the moving body 10 with an obstacle on the basis of the normal vector from the normal vector correction unit 56, the parallax map (point cloud data) from the parallax estimation unit 57, and the velocity vector from the self-position estimation unit 63.

The obstacle collision determination unit 64 includes a division unit 64a, a calculation unit 64b, and a setting unit 64c.

The division unit 64a divides the spatial region in the traveling direction of the moving body 10 into small regions continuous in the traveling direction. Hereinafter, the divided small region is referred to as a collision determination region. The calculation unit 64b calculates a collision risk with an obstacle for each collision determination region divided by the division unit 64a on the basis of the normal vector, the point cloud data, and the velocity vector. The setting unit 64c sets an obstacle region where an obstacle is likely to exist on the basis of the collision risk for each collision determination region calculated by the calculation unit 64b.

Then, the obstacle collision determination unit 64 generates control information for controlling the movement of the own device on the basis of the distance from the own device (moving body 10) to the obstacle region. That is, the obstacle collision determination unit 64 has a function as a control information generation unit that generates control information for controlling the movement of the moving body 10 on the basis of the collision risk.

The flight controller 65 corresponds to the movement control unit 23 in FIG. 4, and controls the movement of the moving body 10 on the basis of the control information generated by the obstacle collision determination unit 64 (control information generation unit).

Note that the obstacle collision determination unit 64 can generate control information or the flight controller 65 can control the movement of the moving body 10 on the basis of a control signal input from a controller for operating the own device (moving body 10). The controller can not only input a control signal for controlling the movement of the moving body 10 in real time, but also input, for example, a destination, a moving route, and the like as the control signal. In this case, the flight controller 65 controls the movement of the moving body 10 so as to autonomously move the moving body 10 on the basis of the destination or the moving route input as the control signal.

### (Obstacle Detection Processing)

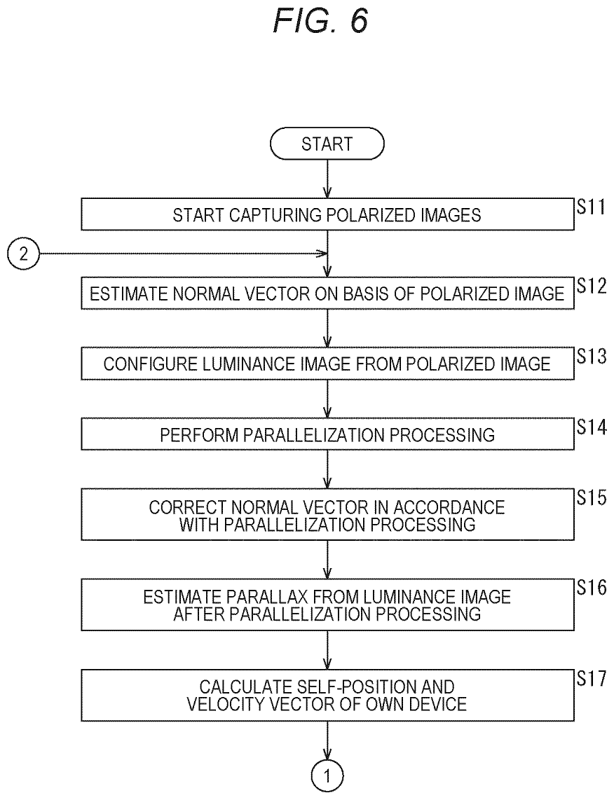

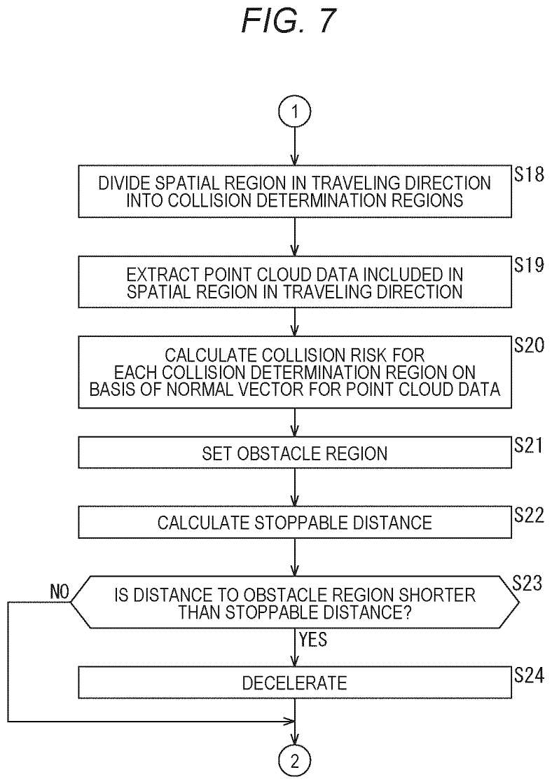

The flow of the obstacle detection processing by the moving body 10 in FIG. 5 will be described with reference to the flowcharts in FIGS. 6 and 7.

In step S11, the polarization cameras 30-1 and 30-2 (polarization image sensors 51-1 and 51-2) start capturing polarized images.

In step S12, the normal vector estimation unit 52 estimates a normal vector on the basis of the polarized image captured by the polarization camera 30-1 or the polarization camera 30-2.

In step S13, the luminance image construction units 53-1 and 53-2 configure luminance images from two-view polarized images captured by the polarization cameras 30-1 and 30-2, respectively.

In step S14, the parallelization processing units 54-1 and 54-2 perform parallelization processing on the two-view luminance images configured by the luminance image construction units 53-1 and 53-2, respectively.

In step S15, the normal vector correction unit 56 corrects the normal vector in accordance with the parallelization processing by the parallelization processing units 54-1 and 54-2.

In step S16, the parallax estimation unit 57 estimates the parallax from the luminance image after the parallelization processing.

In step S17, the self-position estimation unit 63 calculates the self-position and the velocity vector of the own device (moving body 10) on the basis of the data obtained by each of the visual odometry unit 58, the GPS sensor 59, the IMU 60, the barometer 61, and the geomagnetic sensor 62.

In step S18 of FIG. 7, the division unit 64a of the obstacle collision determination unit 64 divides the spatial region in the traveling direction (velocity vector direction) into collision determination regions according to the distance measurement accuracy from the own device (moving body 10).

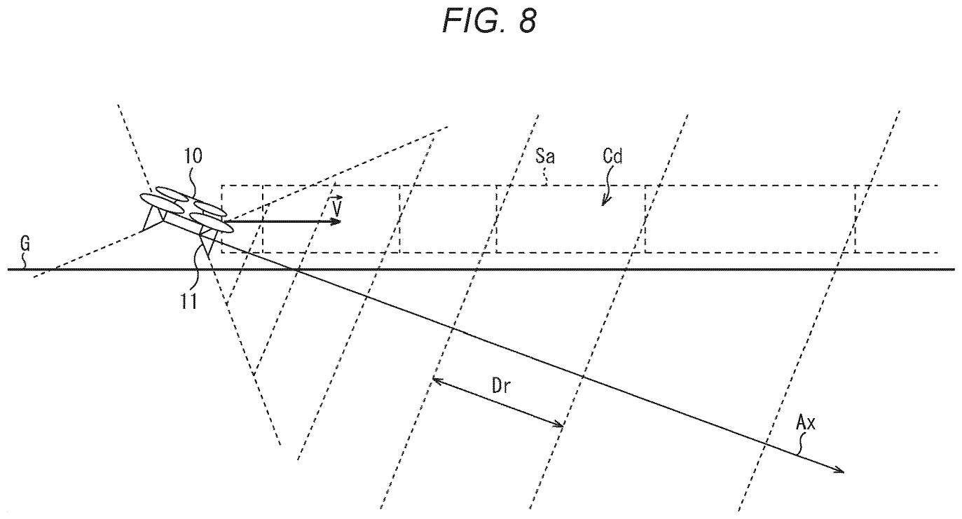

The division of the collision determination region will be described with reference to FIG. 8.

For example, the division unit 64a divides the spatial region Sa through which the moving body 10 passes into the collision determination regions Cd on the basis of the distance Dr according to the distance resolution in the optical axis direction Ax of the distance measuring sensor (the polarization cameras 30-1 and 30-2 as stereo cameras). Since the accuracy of the distance resolution of the distance measuring sensor decreases as the distance measuring sensor becomes farther from the own device, the distance Dr increases as the distance measuring sensor becomes farther from the own device. The length of the collision determination region Cd in the direction of the velocity vector v (depth direction) is set according to the distance Dr. That is, the length of the collision determination region Cd in the direction of the velocity vector v increases as the distance from the own device increases.

Returning to the flowchart of FIG. 7, in step S19, the calculation unit 64b extracts the point cloud data included in the spatial region in the traveling direction (velocity vector direction) from the parallax map (point cloud data).

In step S20, the calculation unit 64b calculates the collision risk for each collision determination region on the basis of the normal vector for the extracted point cloud data.

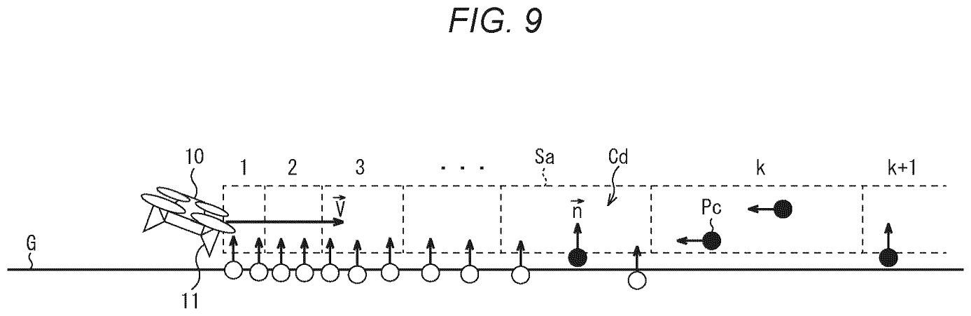

The calculation of the collision risk for each collision determination region will be described with reference to FIG. 9.

In FIG. 9, the spatial region Sa in the velocity vector v direction is divided into 1, 2, 3, . . . , k, k+1th collision determination region Cd, and the normal vector n for the point cloud data Pc included in each collision determination region Cd is illustrated.

Here, assuming that the number i of point cloud data included in the k-th collision determination region Cd is N, the collision risk Rₖ of the k-th collision determination region Cd is expressed by following Equation (1).

$$\begin{matrix}[ Math . 1 ] & \\ {R}_{k} = {\sum }_{i = 0}^{N} \{ ( {R}_{area} + {R}_{count} ) \cdot {R}_{normal} \} & ( 1 )\end{matrix}$$

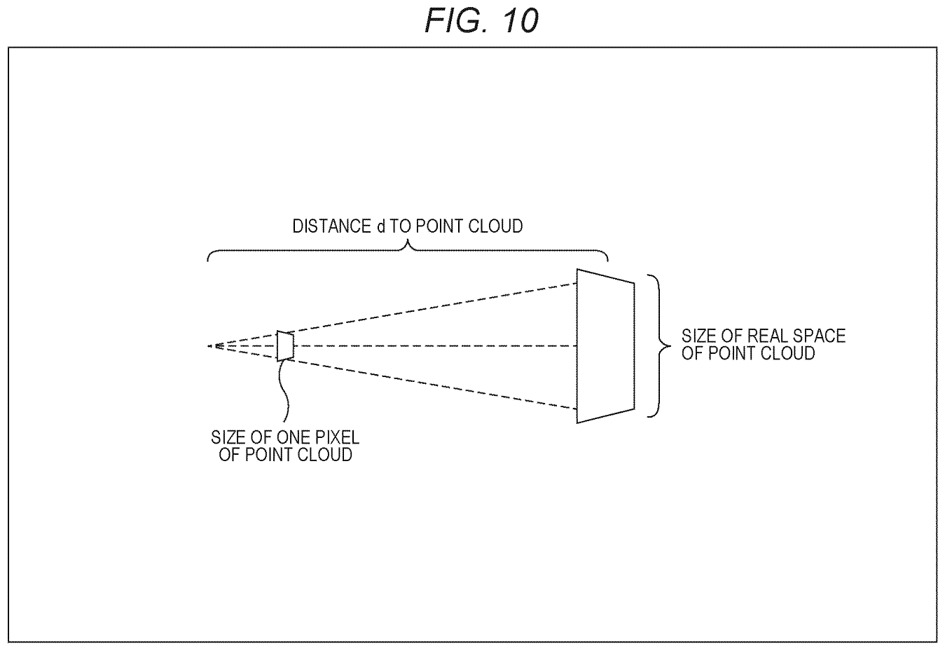

The Rₐᵣₑₐ in Equation (1) is a value proportional to the area of the real space corresponding to each pixel of the point cloud data 1. As illustrated in FIG. 10, assuming that the distance to the point cloud data is d, and the focal lengths in the horizontal direction and the vertical direction of the polarization camera 30-1 or the polarization camera 30-2 are fₓ and f_{y}, respectively, the Rₐᵣₑₐ is expressed by following Equation (2).

$$\begin{matrix}[ Math . 2 ] & \\ {R}_{a r e a} = {ω}_{area} \cdot \frac{d}{{f}_{x}} \cdot \frac{d}{{f}_{y}} & ( 2 )\end{matrix}$$

In Equation (2), the product of d/fₓ and d/f_{y} is proportional to the area of the real space corresponding to one pixel of the point cloud data, and ωₐᵣₑₐ is a fixed weight parameter.

The R_{count} in Equation (1) is a value (weight) uniformly set for each point cloud data, and is expressed by following Equation (3).

$$\begin{matrix}[ Math . 3 ] & \\ {R}_{count} = {ω}_{c o u n t} & ( 3 )\end{matrix}$$

In Equation (3), ω_{count} is the total number of point cloud data included in the collision determination region Cd, and is a value for preventing the above-described Rₐᵣₑₐ proportional to the area of the real space from becoming too small in a case where there is an obstacle at a close distance.

Rₙₒᵣₘₐₗ in Equation (1) is a value (gain) calculated on the basis of the normal vector n for each point cloud data, and is expressed by following Equation (4) using an inner product of the velocity vector v and the normal vector n of each point cloud data.

$$\begin{matrix}[ Math . 4 ] & \\ {R}_{normal} = {ω}_{normal} \cdot \vert \vec{v} \cdot \vec{n} \vert & ( 4 )\end{matrix}$$

In Equation (4), ωₙₒᵣₘₐₗ is a fixed weight parameter. In addition, the absolute value of the inner product of the velocity vector v and the normal vector n of each point cloud data increases as the traveling direction of the moving body 10 and the surface of the subject face each other. Meanwhile, even in a case where the moving body 10 is flying at a low altitude near the ground, since the traveling direction of the moving body 10 is orthogonal to the normal direction of the ground surface, the absolute value of the inner product of the velocity vector v and the normal vector n of each point cloud data becomes small.

Note that both the velocity vector v and the normal vector n of each point cloud data are vectors in a fixed coordinate system based on the moving body 10.

When the collision risk for each collision determination region is calculated as described above, in step S20, the setting unit 64c sets an obstacle region where an obstacle is likely to exist on the basis of the calculated collision risk for each collision determination region.

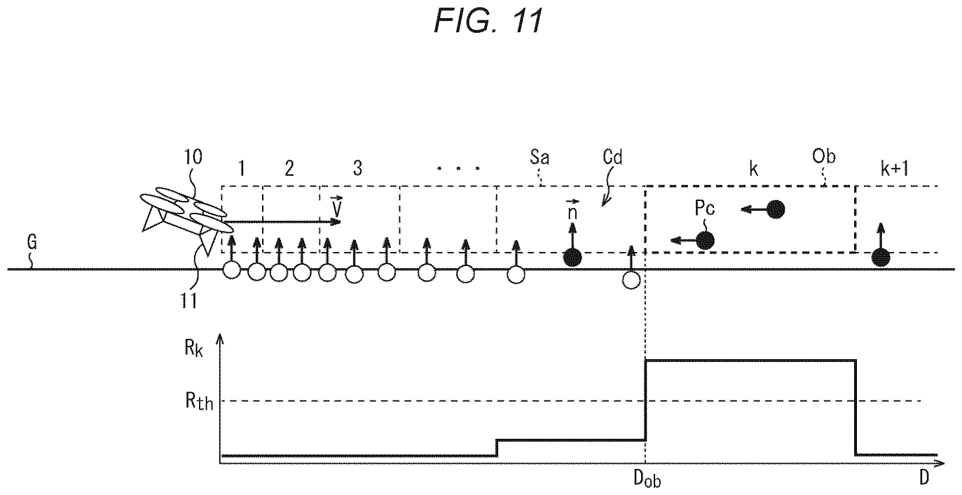

Setting of the obstacle region will be described with reference to FIG. 11.

In FIG. 11, the distance D from the moving body 10 to each collision determination region Cd and the collision risk Rₖ of each collision determination region Cd are illustrated for the first to k+1th collision determination regions Cd.

The setting unit 64c sets, as the obstacle region Ob, a collision determination region Cd in which the collision risk Rₖ is higher than a predetermined threshold Rₜₕ and which is closest to the own device (moving body 10). In the example of FIG. 11, a k-th collision determination region Cd in which the collision risk Rₖ is higher than a predetermined threshold Rₜₕ and which is closest to the own device (moving body 10) is set as the obstacle region Ob.

Returning to the flowchart of FIG. 7, in step S21, the obstacle collision determination unit 64 calculates a stoppable distance (braking distance) necessary for stopping the own device (moving body 10) from the current speed on the basis of the velocity vector v. The stoppable distance may include a margin of, for example, 5 m or the like.

In step S23, the obstacle collision determination unit 64 determines whether or not the distance to the obstacle region is shorter than the calculated stoppable distance. In a case where it is determined that the distance to the obstacle region is shorter than the stoppable distance, the process proceeds to step S24.

For example, in the example of FIG. 11, in a case where the distance D_{ob} to the obstacle region Ob is shorter than the stoppable distance, there is a risk of colliding with an obstacle that may exist in the obstacle region Ob as it is. Therefore, in a case where it is determined that the distance to the obstacle region is shorter than the stoppable distance, the obstacle collision determination unit 64 generates control information for decelerating the moving body 10 to a speed at which the moving body 10 can stop before the obstacle, and outputs the control information to the flight controller 65.

In step S24, the flight controller 65 decelerates the moving body 10 on the basis of the control information generated by the obstacle collision determination unit 64. Here, the moving body 10 is decelerated by generating the control information for decelerating to a speed at which the moving body can stop before the obstacle. However, the moving body 10 may be stopped by generating the control information for stopping before the obstacle.

Meanwhile, in the example of FIG. 11, in a case where the distance D_{ob} to the obstacle region Ob is longer than the stoppable distance, the moving body 10 can stop before the obstacle that may exist in the obstacle region Ob, and thus step S24 is skipped.

Thereafter, the process returns to step S12, and the processes of steps S12 to S24 are repeated.

According to the above processing, the movement of the own device is controlled using the normal vector estimated on the basis of the polarized image obtained by imaging the traveling direction of the own device, and thus, it is possible to suppress erroneous determination in obstacle detection even in a case where the moving body 10 is flying at a low altitude. As a result, the user can perform a more natural manual operation.

### 4. SECOND EMBODIMENT

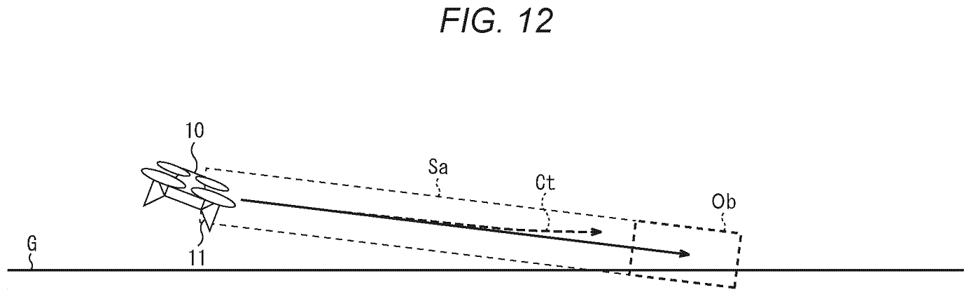

In the second embodiment, as illustrated in FIG. 12, in a case where the ground G is included in the obstacle region Ob in the spatial region Sa through which the moving body 10 flying at a high speed passes, not only deceleration but also avoidance of collision with an obstacle by the corrected trajectory Ct is realized.

### (Functional Configuration Example of Moving Body)

FIG. 12 is a block diagram illustrating a functional configuration example of a moving body 10 according to a second embodiment to which the technology according to the present disclosure is applied.

A moving body 10A illustrated in FIG. 12 basically has a similar configuration to the moving body 10 in FIG. 5. However, in the moving body 10A of FIG. 12, the obstacle collision determination unit 64 includes a representative normal vector calculation unit 64d and an angular acceleration calculation unit 64e in addition to the division unit 64a, the calculation unit 64b, and the setting unit 64c.

The representative normal vector calculation unit 64d calculates a normal vector being representative (hereinafter, referred to as a representative normal vector) in the obstacle region on the basis of the normal vector for the point cloud data included in the obstacle region set by the setting unit 64c.

The angular acceleration calculation unit 64e predicts a velocity vector when the own device (moving body 10A) reaches the obstacle region, and calculates angular acceleration such that the velocity vector (predicted velocity vector) and the representative normal vector calculated by the representative normal vector calculation unit 64d are orthogonal to each other.

As a result, the obstacle collision determination unit 64 can generate control information for correcting the trajectory of the own device such that the predicted velocity vector and the representative normal vector are orthogonal to each other.

### (Obstacle Detection Processing)

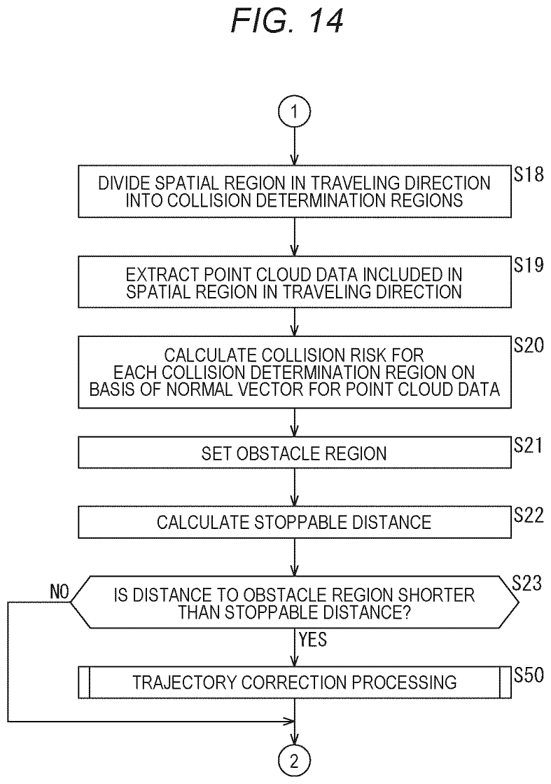

The flow of the obstacle detection processing by the moving body 10A of FIG. 12 will be described with reference to the flowchart of FIG. 14.

Note that the processing up to step S23 in the flowchart of FIG. 14 is executed in a similar manner to the flow of the obstacle detection processing by the moving body 10 of FIG. 5 described with reference to the flowcharts of FIGS. 6 and 7.

That is, in a case where it is determined in step S23 that the distance to the obstacle region is shorter than the stoppable distance, the process proceeds to step S50. In step S50, the obstacle collision determination unit 64 executes trajectory correction processing.

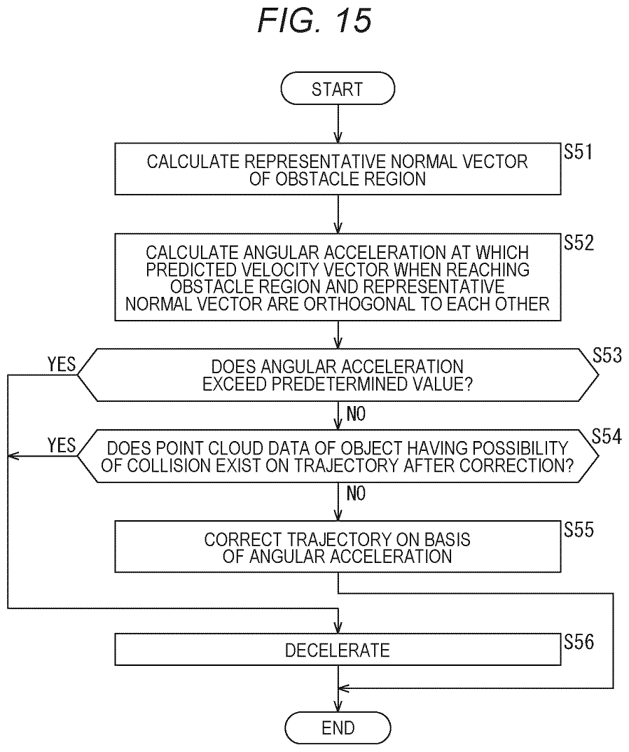

FIG. 15 is a flowchart for explaining a flow of trajectory correction processing.

In step S51, the representative normal vector calculation unit 64d of the obstacle collision determination unit 64 calculates a representative normal vector of the obstacle region.

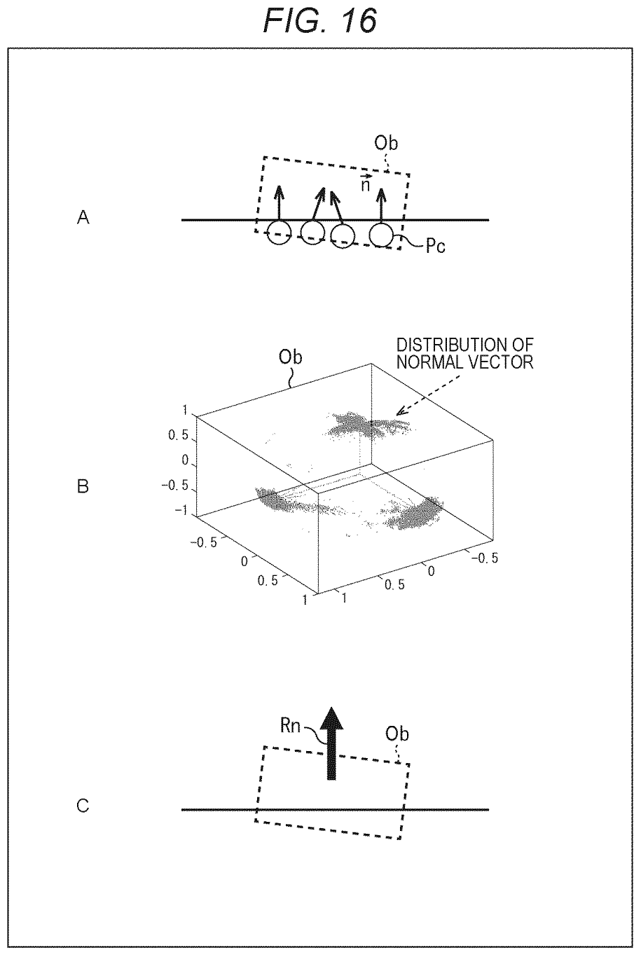

The calculation of the representative normal vector will be described with reference to FIG. 16.

A of FIG. 16 illustrates a normal vector n for the point cloud data Pc included in the obstacle region Ob.

FIG. B illustrates a distribution of the normal vector n in the obstacle region Ob. The representative normal vector calculation unit 64d analyzes the distribution of the normal vector n, and determines the vector in the most dominant direction in the obstacle region Ob as the representative normal vector Rn illustrated in C of the drawing.

When the representative normal vector of the obstacle region is calculated as described above, in step S52, the angular acceleration calculation unit 64e calculates the angular acceleration at which the predicted velocity vector when the own device (moving body 10A) reaches the obstacle region and the representative normal vector are orthogonal to each other.

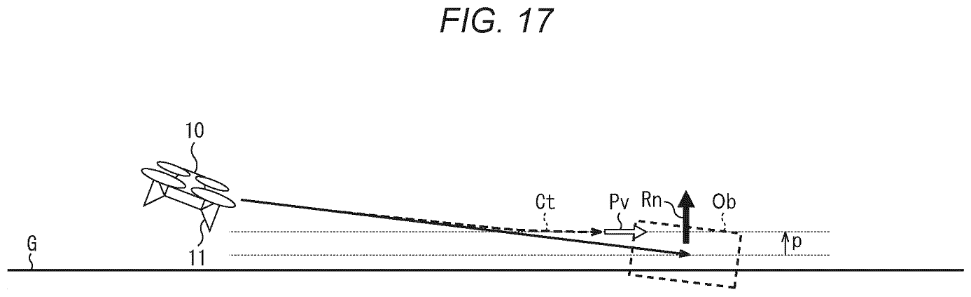

Specifically, as illustrated in FIG. 17, the angular acceleration for realizing the flight of the corrected trajectory Ct in which the predicted velocity vector Pv and the representative normal vector Rn are orthogonal to each other is calculated at a position away from the center of the obstacle region Ob in the direction of the representative normal vector Rn by a certain distance p.

In step S53, the obstacle collision determination unit 64 determines whether or not the angular acceleration calculated by the angular acceleration calculation unit 64e exceeds a predetermined value. In a case where it is determined that the calculated angular acceleration does not exceed the predetermined value, the process proceeds to step S54.

In step S54, the obstacle collision determination unit 64 determines whether or not point cloud data corresponding to an object having a possibility of collision exists on the trajectory after correction (corrected trajectory). In a case where it is determined that the point cloud data corresponding to the object having a possibility of collision does not exist on the corrected trajectory, the process proceeds to step S55. At this time, the obstacle collision determination unit 64 outputs the angular acceleration calculated by the angular acceleration calculation unit 64e to the flight controller 65 as control information for correcting the trajectory of the own device.

In step S55, the flight controller 65 corrects the trajectory of the own device by controlling the posture of the moving body 10A on the basis of the angular acceleration output as the control information by the obstacle collision determination unit 64. Thereafter, the process returns to step S12 (FIG. 6), and the processes of steps S12 to S23 and S50 are repeated.

Meanwhile, in a case where it is determined in step S53 that the calculated angular acceleration exceeds the predetermined value, or in a case where it is determined in step S54 that the point cloud data corresponding to the object having a possibility of collision exists on the corrected trajectory, the process proceeds to step S56. At this time, the obstacle collision determination unit 64 generates control information for decelerating the moving body 10 to a speed at which the moving body 10 can stop before the obstacle, and outputs the control information to the flight controller 65.

In step S56, the flight controller 65 decelerates the moving body 10A on the basis of the control information generated by the obstacle collision determination unit 64. Thereafter, the process returns to step S12 (FIG. 6), and the processes of steps S12 to S23 and S50 are repeated. Also here, control information for stopping before the obstacle may be generated to stop the moving body 10A.

According to the above processing, since the trajectory of the own device is corrected using the normal vector estimated on the basis of the polarized image obtained by imaging the traveling direction of the own device, it is possible to avoid collision with an obstacle even in a case where the moving body 10A is flying at a high speed.

### 5. THIRD EMBODIMENT

A first person view (FPV) camera having a gimbal mechanism is mounted on a drone, and an image captured by the FPV camera is transmitted to a controller operated by a user, so that the user can remotely operate the drone while viewing the image. However, in the image captured by the FPV camera, it may be difficult to visually recognize the unevenness of the surrounding environment in which the drone flies.

In the third embodiment, the normal vector image generated on the basis of the estimated normal vector is superimposed on the image captured by the FPV camera, thereby realizing the assistance of the user at the time of remote operation of the moving body 10.

### (Functional Configuration Example of Moving Body)

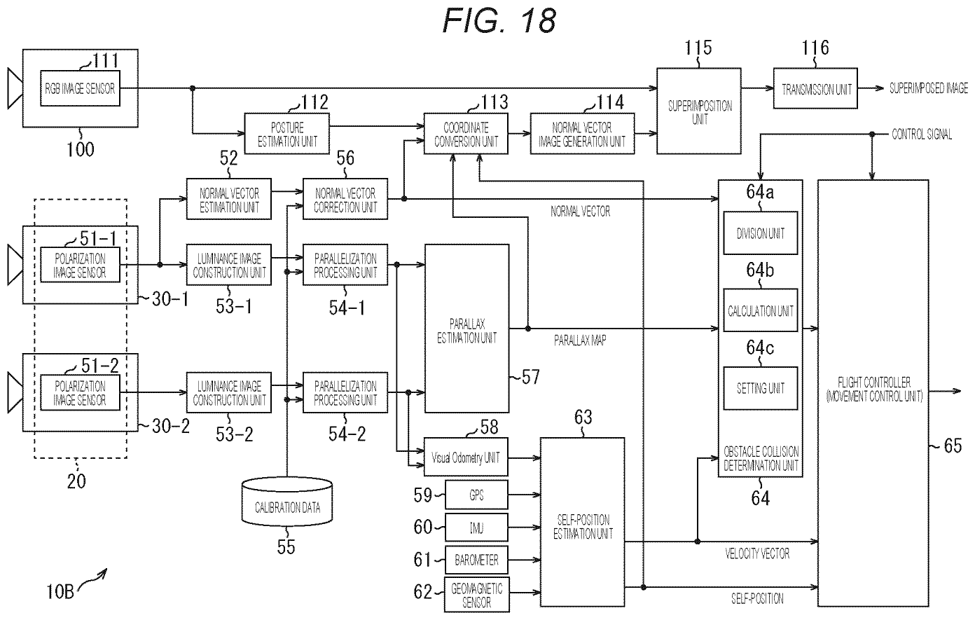

FIG. 18 is a block diagram illustrating a functional configuration example of a moving body 10 according to a third embodiment to which the technology according to the present disclosure is applied.

A moving body 10B illustrated in FIG. 18 includes an FPV camera 100 having an RGB image sensor 111, a posture estimation unit 112, a coordinate conversion unit 113, a normal vector image generation unit 114, a superimposition unit 115, and a transmission unit 116, in addition to a similar configuration to the moving body 10 in FIG. 5. Note that, in the moving body 10B in FIG. 18, the obstacle collision determination unit 64 may include the representative normal vector calculation unit 64d and the angular acceleration calculation unit 64e in addition to the division unit 64a, the calculation unit 64b, and the setting unit 64c.

The FPV camera 100 has a gimbal mechanism and can capture images at various angles. The RGB image sensor 111 included in the FPV camera 100 is configured by arranging R, G, and B color filters on pixels in a Bayer array, for example, and captures RGB images.

On the basis of the RGB image captured by the RGB image sensor 111, the posture estimation unit 112 estimates the current posture of the FPV camera 100 based on the origin position of the camera coordinate system of the FPV camera 100.

The coordinate conversion unit 113 converts the coordinate system of the normal vector map including the normal vector for each pixel position of the polarized image into the camera coordinate system of the FPV camera 100. For the coordinate conversion of the normal vector map, the parallax map from the parallax estimation unit 57, the self-position from the self-position estimation unit 63, the posture information of the polarization cameras 30-1 and 30-2, the relative position of the FPV camera 100 with respect to the polarization cameras 30-1 and 30-2, and the current posture information are used.

The normal vector image generation unit 114 generates a normal vector image colored according to the direction of the normal vector on the basis of the coordinate-converted normal vector map. That is, the normal vector image converted into the camera coordinate system of the FPV camera 100 is generated.

The superimposition unit 115 generates a superimposed image in which the normal vector image generated by the normal vector image generation unit 114 is superimposed on the RGB image captured by the RGB image sensor 111.

The transmission unit 116 corresponds to the communication unit 21 in FIG. 4, and transmits the superimposed image generated by the superimposition unit 115 to a controller for inputting a control signal of the own device (moving body 10B).

### (Superimposed Image Transmission Processing)

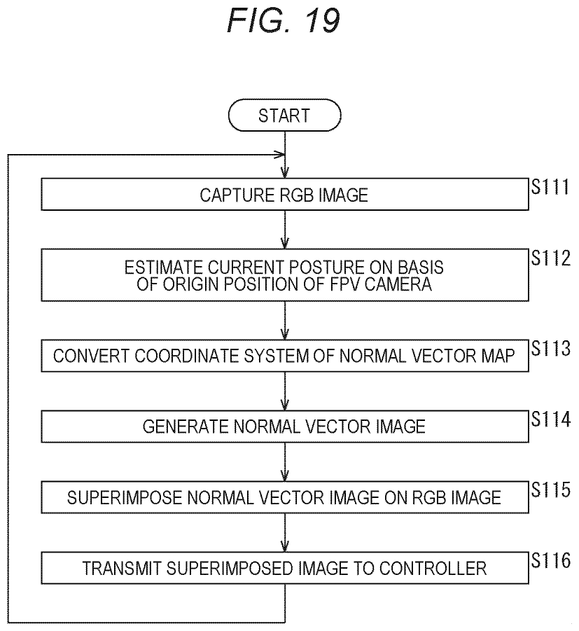

FIG. 19 is a flowchart for explaining a flow of superimposed image processing. The process of FIG. 19 is executed in parallel with the obstacle detection processing described with reference to FIGS. 6, 7, and 14.

In step S111, the FPV camera 100 (the RGB image sensor 111) captures an RGB image.

In step S112, the posture estimation unit 112 estimates a current posture of the FPV camera 100 based on an origin position of a camera coordinate system of the FPV camera 100 on the basis of the captured RGB image.

In step S113, the coordinate conversion unit 113 converts the coordinate system of the normal vector map into the camera coordinate system of the FPV camera 100.

In step S114, the normal vector image generation unit 114 generates a normal vector image colored according to the direction of the normal vector on the basis of the coordinate-converted normal vector map.

In step S115, the superimposition unit 115 superimposes the normal vector image generated by the normal vector image generation unit 114 on the RGB image captured by the RGB image sensor 111.

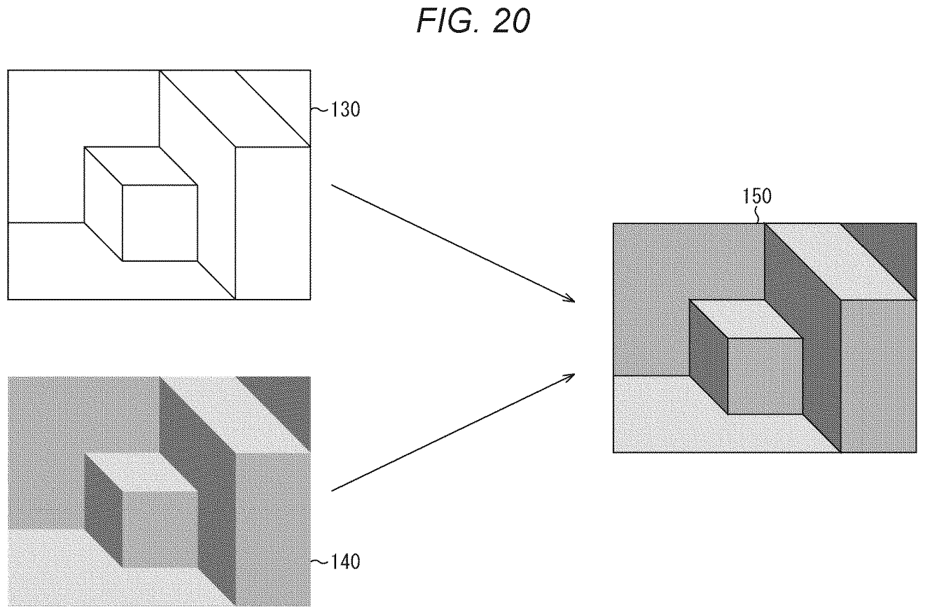

Generation of a superimposed image will be described with reference to FIG. 20.

In a case where the RGB image 130 illustrated in FIG. 20 is an image captured in a dark environment or an image with low contrast, it is difficult for the user who remotely operates the moving body 10B while viewing the RGB image 130 to visually recognize the unevenness of the subject illustrated in the RGB image 130.

Therefore, the normal vector image generation unit 114 generates the normal vector image 140 colored according to the direction of the normal vector on the basis of the normal vector map, and the superimposition unit 115 generates the superimposed image 150 in which the normal vector image 140 is superimposed on the RGB image 130.

As a result, an image in which the unevenness of the subject is easily visually recognized is obtained.

Returning to the flowchart of FIG. 19, in step S116, the transmission unit 116 transmits the superimposed image generated by the superimposition unit 115 to a controller for inputting a control signal of the own device (moving body 10B). The process returns to step S111, and the above-described process is repeated.

According to the above process, it is possible to obtain an image in which the unevenness of the subject can be easily visually recognized, and it is possible to realize the assistance of the user at the time of remote operation of the moving body 10B.

Note that, in the present embodiment, only the normal vector image may be transmitted to the controller without providing the FPV camera 100.

### 6. MODIFICATION

Hereinafter, modifications of the above-described embodiments will be described.

In the above-described embodiments, the sensor 20 that realizes the estimation of the normal vector and the distance measurement is configured by the polarization image sensors 51-1 and 51-2 constituting the two-view stereo camera.

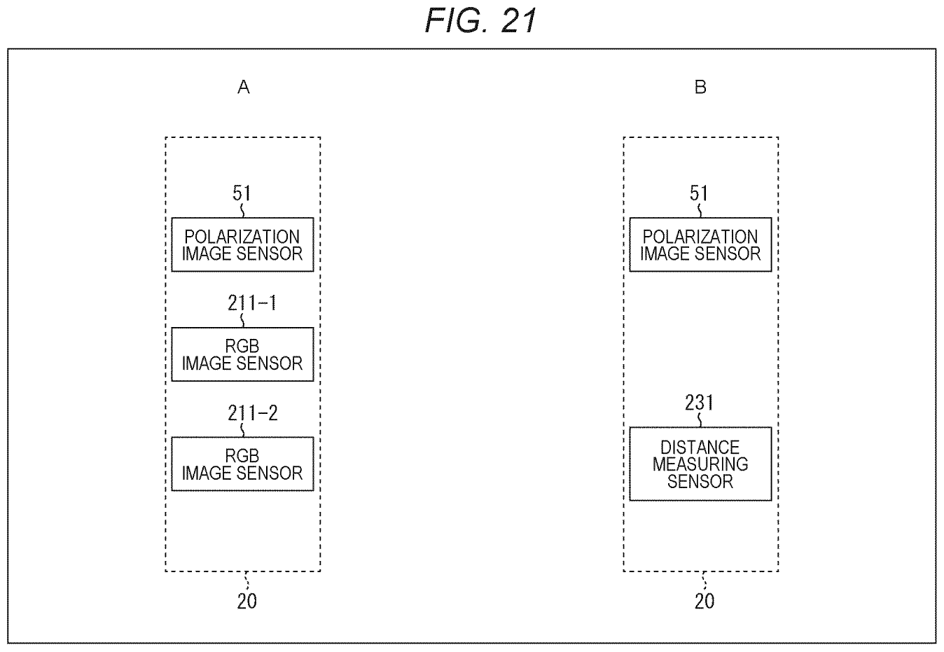

Alternatively, as illustrated in A of FIG. 21, the sensor 20 may include a polarization image sensor 51 and RGB image sensors 211-1 and 211-2 constituting a two-view stereo camera.

Similarly, as illustrated in B of FIG. 21, the sensor 20 may include a polarization image sensor 51 and a distance measuring sensor 231 such as a light detection and ranging (LiDAR) or a time of flight (ToF) sensor.

In any configuration, the sensor 20 can realize estimation of a normal vector and distance measurement.

Furthermore, in the above-described embodiments, the normal vector is estimated on the basis of the polarized image acquired by the polarization image sensor.

In addition to this, the normal vector can be estimated on the basis of sensor data in which the traveling direction of the own device (moving body 10) is sensed by a predetermined sensor. For example, it is possible to estimate the normal vector on the basis of data obtained by performing predetermined processing on depth information acquired by a general stereo camera or a distance measuring device such as LiDAR.

In the above-described embodiments, the configuration from the configuration for estimating the normal vector (normal vector estimation unit 52) to the configuration for determining collision with an obstacle (obstacle collision determination unit 64) is realized by the control unit 22 in FIG. 4.

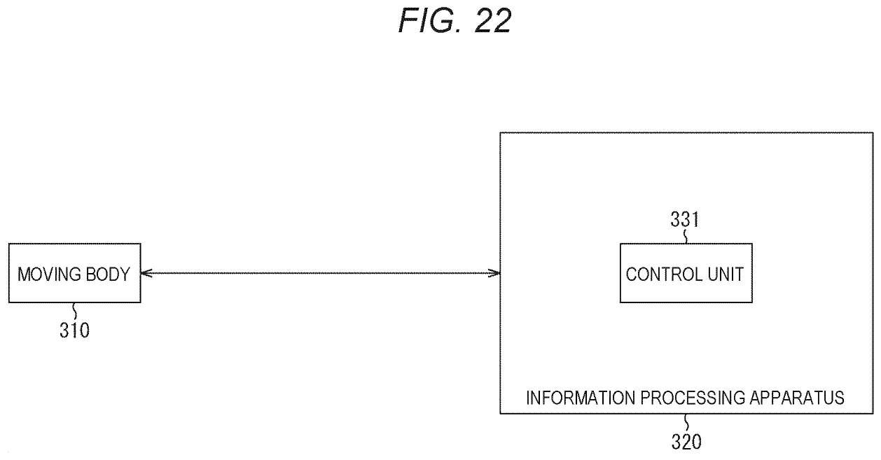

These configurations may be realized by the control unit 331 included in the information processing apparatus 320 in a case where the movement of the moving body 310 is controlled by the information processing apparatus 320 configured on a cloud, for example, in the moving body control system illustrated in FIG. 22. In this case, the control unit 331 estimates a normal vector on the basis of the sensor data transmitted from the moving body 310, and generates control information for controlling the movement of the moving body 310 on the basis of the normal vector. The generated control information is transmitted to the moving body 310.

Also in the above configuration, it is possible to suppress erroneous determination in obstacle detection in a case where the moving body 310 is flying at a low altitude.

The moving body 10 to which the technology according to the present disclosure is applied has been described as exhibiting the effect in a case where the moving body is flying at a low altitude near the ground. However, the moving body 10 to which the technology according to the present disclosure is applied can also exhibit the effect in a case where the moving body is moving along a wall surface, for example.

### 7. CONFIGURATION EXAMPLE OF COMPUTER

The above-described series of processing can be executed by hardware or software. In a case where the series of processing is executed by software, a program constituting the software is installed in a computer. Here, examples of the computer include a computer incorporated in dedicated hardware, and for example, a general-purpose personal computer capable of executing various functions by installing various programs.

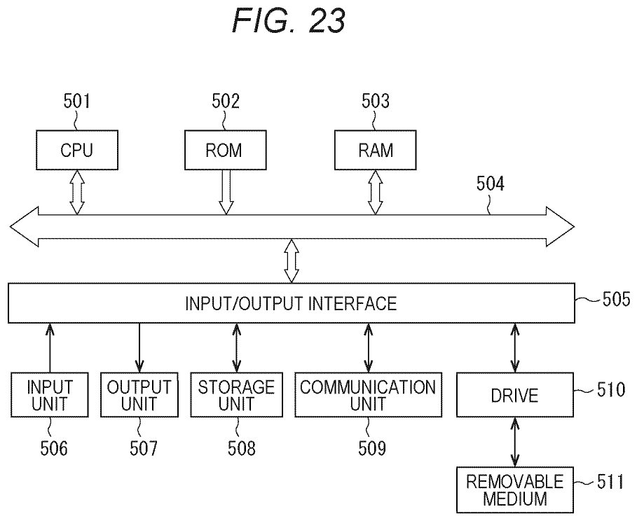

FIG. 23 is a block diagram illustrating a configuration example of hardware of a computer that executes the above-described series of processing by a program.

In the computer, a CPU 501, a read only memory (ROM) 502, and a random access memory (RAM) 503 are mutually connected by a bus 504.

An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, and the like. The output unit 507 includes a display, a speaker, and the like. The storage unit 508 includes a hard disk, a non-volatile memory and the like. The communication unit 509 includes, for example, a network interface and the like. The drive 510 drives a removable medium 511 such as a magnetic disk, an optical disk, a magneto-optical disk, or a semiconductor memory.

In the computer configured as described above, for example, the CPU 501 loads a program stored in the storage unit 508 into the RAM 503 via the input/output interface 505 and the bus 504 and executes the program, whereby the above-described series of processing is performed.

The program executed by the computer (CPU 501) can be provided by being recorded on, for example, a removable medium 511 as a package medium or the like. Furthermore, the program can be provided via a wired or wireless transmission medium such as a local area network, the Internet, or digital satellite broadcasting.

In the computer, the program can be installed in the storage unit 508 via the input/output interface 505 by mounting the removable medium 511 to the drive 510. Furthermore, the program can be received by the communication unit 509 via a wired or wireless transmission medium and installed in the storage unit 508. In addition, the program can be installed in the ROM 502 or the storage unit 508 in advance.

Note that the program executed by the computer may be a program for processing in time series in the order described in the present specification, or a program for processing in parallel or at a necessary timing such as when a call is made.

The embodiments of the present disclosure are not limited to the above-described embodiments, and various modifications can be made without departing from the gist of the present disclosure.

The effects described in the present specification are merely examples and are not limited, and other effects may be provided.

Moreover, the technology according to the present disclosure can have the following configurations.
(1)

A moving body including:
a normal vector estimation unit that estimates a normal vector on the basis of sensor data obtained by sensing a traveling direction of an own device; and
a control information generation unit that generates control information for controlling movement of the own device on the basis of the normal vector.
(2)

The moving body according to (1), further including
a calculation unit that calculates a collision risk with an obstacle on the basis of the normal vector,
in which the control information generation unit generates the control information on the basis of the collision risk.
(3)

The moving body according to (2),
in which the calculation unit calculates the collision risk on the basis of the normal vector for point cloud data according to a distance from the own device.
(4)

The moving body according to (3), further including
a division unit that divides a spatial region in the traveling direction into collision determination regions continuous in the traveling direction,
in which the calculation unit calculates the collision risk for each collision determination regions on the basis of the normal vector for the point cloud data included in the collision determination region.
(5)

The moving body according to (4),
in which the division unit divides the spatial region into the collision determination regions according to a distance measurement accuracy from the own device.
(6)

The moving body according to (4) or (5),
in which the calculation unit calculates the collision risk for each collision determination region by using an inner product of the normal vector and a velocity vector of the own device obtained for the point cloud data included in the collision determination region.
(7)

The moving body according to (6),
in which the calculation unit calculates a value corresponding to a sum of products of the inner product and a value proportional to an area of a real space corresponding to the point cloud data, of each of the point cloud data included in the collision determination region, as the collision risk of the collision determination region.
(8)

The moving body according to any one of (4) to (7), further including
a setting unit that sets the collision determination region in which the collision risk is higher than a predetermined threshold and which is closest to the own device as an obstacle region where there is a possibility that the obstacle is present,
in which the control information generation unit generates the control information on the basis of a distance from the own device to the obstacle region.
(9)

The moving body according to (8),
in which the control information generation unit generates the control information for decelerating the own device in a case where a distance from the own device to the obstacle region is shorter than a stoppable distance of the own device.
(10)

The moving body according to (8) or (9), further including
a representative normal vector calculation unit that calculates a representative normal vector in the obstacle region on the basis of the normal vector for the point cloud data included in the obstacle region,
in which the control information generation unit generates the control information for correcting a trajectory of the own device such that a predicted velocity vector when the own device reaches the obstacle region and the representative normal vector are orthogonal to each other.
(11)

The moving body according to (10),
in which the control information generation unit calculates, as the control information, an angular acceleration at which the predicted velocity vector and the representative normal vector are orthogonal to each other.
(12)

The moving body according to (11),
in which the control information generation unit generates the control information for correcting the trajectory in a case where the angular acceleration does not exceed a predetermined value and the point cloud data corresponding to an object having a possibility of collision does not exist on the trajectory after correction.
(13)

The moving body according to (12),
in which the control information generation unit generates the control information for decelerating the own device in a case where the angular acceleration exceeds the predetermined value or the point cloud data corresponding to the object exists on the trajectory after correction.
(14)

The moving body according to any one of (1) to (13), further including:
a normal vector image generation unit that generates a normal vector image on the basis of the normal vector; and
a superimposition unit that generates a superimposed image in which the normal vector image is superimposed on an RGB image captured by a first person view (FPV) camera.
(15)

The moving body according to (14),
in which the normal vector image generation unit generates the normal vector image colored according to a direction of the normal vector.
(16)

The moving body according to (14) or (15),
in which the normal vector image generation unit generates the normal vector image converted into a coordinate system of the FPV camera.
(17)

The moving body according to any one of (14) to (16), further including
a transmission unit that transmits the superimposed image to a controller for inputting a control signal of the own device.
(18)

The moving body according to any one of (1) to (17),
in which the sensor data is a polarized image captured by a polarization image sensor.
(19)

A movement control method including:
estimating a normal vector on the basis of sensor data obtained by sensing an object in a traveling direction of a moving body; and
generating control information for controlling movement of the moving body on the basis of the normal vector.
(20)

A program for causing a computer to execute processing of:
estimating a normal vector on the basis of sensor data obtained by sensing an object in a traveling direction of a moving body; and
generating control information for controlling movement of the moving body on the basis of the normal vector.

### REFERENCE SIGNS LIST

10 Moving body
20 Sensor
22 Control unit
30-1, 30-2 Polarization camera
51, 51-1, 51-2 Polarization image sensor
52 Normal vector estimation unit
64 Obstacle collision determination unit
64a Division unit
64b Calculation unit
64c Setting unit
64d Representative normal vector calculation unit
64e Angular acceleration calculation unit
65 Flight controller

1. A moving body comprising:
a normal vector estimation unit that estimates a normal vector on a basis of sensor data obtained by sensing a traveling direction of an own device; and
a control information generation unit that generates control information for controlling movement of the own device on a basis of the normal vector.

2. The moving body according to claim 1, further comprising
a calculation unit that calculates a collision risk with an obstacle on a basis of the normal vector,
wherein the control information generation unit generates the control information on a basis of the collision risk.

3. The moving body according to claim 2,
wherein the calculation unit calculates the collision risk on a basis of the normal vector for point cloud data according to a distance from the own device.

4. The moving body according to claim 3, further comprising
a division unit that divides a spatial region in the traveling direction into collision determination regions continuous in the traveling direction,
wherein the calculation unit calculates the collision risk for each collision determination regions on a basis of the normal vector for the point cloud data included in the collision determination region.

5. The moving body according to claim 4,
wherein the division unit divides the spatial region into the collision determination regions according to a distance measurement accuracy from the own device.

6. The moving body according to claim 4,
wherein the calculation unit calculates the collision risk for each collision determination region by using an inner product of the normal vector and a velocity vector of the own device obtained for the point cloud data included in the collision determination region.

7. The moving body according to claim 6,
wherein the calculation unit calculates a value corresponding to a sum of products of the inner product and a value proportional to an area of a real space corresponding to the point cloud data, of each of the point cloud data included in the collision determination region, as the collision risk of the collision determination region.

8. The moving body according to claim 4, further comprising
a setting unit that sets the collision determination region in which the collision risk is higher than a predetermined threshold and which is closest to the own device as an obstacle region where there is a possibility that the obstacle is present,
wherein the control information generation unit generates the control information on a basis of a distance from the own device to the obstacle region.

9. The moving body according to claim 8,
wherein the control information generation unit generates the control information for decelerating the own device in a case where a distance from the own device to the obstacle region is shorter than a stoppable distance of the own device.

10. The moving body according to claim 8, further comprising
a representative normal vector calculation unit that calculates a representative normal vector in the obstacle region on a basis of the normal vector for the point cloud data included in the obstacle region,
wherein the control information generation unit generates the control information for correcting the trajectory of the own device such that a predicted velocity vector when the own device reaches the obstacle region and the representative normal vector are orthogonal to each other.

11. The moving body according to claim 10,
wherein the control information generation unit calculates, as the control information, an angular acceleration at which the predicted velocity vector and the representative normal vector are orthogonal to each other.

12. The moving body according to claim 11,
wherein the control information generation unit generates the control information for correcting the trajectory in a case where the angular acceleration does not exceed a predetermined value and the point cloud data corresponding to an object having a possibility of collision does not exist on the trajectory after correction.

13. The moving body according to claim 12,
wherein the control information generation unit generates the control information for decelerating the own device in a case where the angular acceleration exceeds the predetermined value or the point cloud data corresponding to the object exists on the trajectory after correction.

14. The moving body according to claim 1, further comprising:
a normal vector image generation unit that generates a normal vector image on a basis of the normal vector; and
a superimposition unit that generates a superimposed image in which the normal vector image is superimposed on an RGB image captured by a first person view (FPV) camera.

15. The moving body according to claim 14,
wherein the normal vector image generation unit generates the normal vector image colored according to a direction of the normal vector.

16. The moving body according to claim 14,
wherein the normal vector image generation unit generates the normal vector image converted into a coordinate system of the FPV camera.

17. The moving body according to claim 14, further comprising
a transmission unit that transmits the superimposed image to a controller for inputting a control signal of the own device.

18. The moving body according to claim 1,
wherein the sensor data is a polarized image captured by a polarization image sensor.

19. A movement control method comprising:
estimating a normal vector on a basis of sensor data obtained by sensing an object in a traveling direction of a moving body; and
generating control information for controlling movement of the moving body on a basis of the normal vector.

20. A program for causing a computer to execute processing of:
estimating a normal vector on a basis of sensor data obtained by sensing an object in a traveling direction of a moving body; and
generating control information for controlling movement of the moving body on a basis of the normal vector.
